(19) United States
(12) Patent Application Publication
(10) Pub. No.: US 2013/0013108 A1
(43) Pub. Date: Jan. 10, 2013

(54) Robotic Agile Lift System With Extremity Control

(75) Inventors: Stephen C. Jacobsen, Salt Lake City, UT (US); John McCullough, Salt Lake City, UT (US); Marc X. Olivier, Salt Lake City, UT (US)

(73) Assignee: Raytheon Company, Waltham, MA (US)

(21) Appl. No.: 13/332,146

(22) Filed: Dec. 20, 2011

Related U.S. Application Data
(60) Provisional application No. 61/481,099, filed on Apr. 29, 2011.
(60) Provisional application No. 61/481,110, filed on Apr. 29, 2011.
(60) Provisional application No. 61/481,103, filed on Apr. 29, 2011.

(51) Int. Cl. G06F 19/00

(52) U.S. Cl. 700/250; 700/245

(57) ABSTRACT

A mobile robotic lift assistance system that can accommodate and provide for operator manipulation and control of a robotic arm and associated end effector locally from and via the robotic arm itself, and within a zone of operation. The mobile robotic lift assistance system can include one or more robotic arms having an associated extremity control system operable therefrom, wherein the operator enters the zone of operation and engages a control interface device to manipulate and control the robotic arm, any end effector associated therewith, and optionally the mobile platform unit. The control interface system facilitates extremity control by the operator of the mobile robotic lift assistance system.

### PRIORITY DATA

This application claims the benefit of U.S. Provisional Application Ser. No. 61/481,099, filed Apr. 29, 2011, which is incorporated by reference herein in its entirety. This application also claims the benefit of U.S. Provisional Application Ser. Nos. 61/481,110, filed Apr. 29, 2011; 61/481,103, filed Apr. 29, 2011; 61/481,089, filed Apr. 29, 2011; 61/481,095, filed Apr. 29, 2011; and 61/481,091, filed Apr. 29, 2011, each of which are incorporated by reference herein in their entirety.

### BACKGROUND

Lifting and transporting objects and items from one location to another often presents considerable problems in terms of not being safe, efficient and/or cost effective. These problems can be exacerbated in those industries and environments (e.g., shipyards, warehouses, military deployment locations, etc.) where all of the lifting and/or transporting of objects or items is required to be done manually due to the unavailability of lift or transport assistance systems, or where a part of the lifting and/or transporting of objects is done with at least some assistance, but the assistance is done with an available lift or transport assistance system limited in its functionality, thus making its use impractical or ineffective for certain tasks.

The difficulty of lifting and/or transporting objects from one location to another, or even the inability to do so, when such is needed is commonly referred to as a “lift gap,” with the discipline being referred to as “gap logistics.” Currently, there are several so called “lift gaps” associated with payloads of up to 400 lbs presenting considerable problems and challenges in public, private and military settings. In many cases, logistics personnel are often required to lift, transport or otherwise manipulate heavy or bulky payloads in any way possible, sometimes with the help of awkward and ineffective and/or inefficient assistance systems, and sometimes manually without assistance.

One illustrative example is in logistics (e.g., military or other types of logistics settings), which can comprise the discipline of carrying out the movement, maintenance and support of various objects. In short, logistics can include the aspects of acquisition, storage, distribution, transport, maintenance, evacuation, and preparation of material and equipment. Whatever the setting, logistics support personnel often faces the challenge of lifting and transporting equipment that can weigh up to several hundred pounds or more, thus posing significant logistics problems. Moving these about can require great effort on the part of logistics personnel, even with the help of the limited functionality assistance systems made available to them. Additional challenges or problems exist when there is a large number of objects required to be lifted and transported, particularly on a daily basis, even if these objects weigh less than the relatively heavier objects. Indeed, it is not uncommon for logistics personnel to each lift and transport several thousand pounds a day, sometimes over difficult terrain. Moreover, much of this is done manually, unfortunately leading to a variety of orthopedic and other injuries, as well as a high rate in personnel turnover.

Moreover, in conventional operator controlled lift and/or transport assistance systems, such as forklifts, cranes, hoists, jacks, platform lifts, etc. the controls of the assistance system are appropriately located about the assistance system at a location away from those structural components or elements charged with the physical lifting and/or transporting of objects, thereby locating the operator away from the zone of operation (zone where lifting and moving of objects occurs and where the various structural components of the lift assistance system are doing the lifting). This scenario is typical of most lift systems in part due to the fact that such assistance systems are typically designed for one or more specific, but limited, purposes or tasks, wherein they are configured to effectively carry out such tasks, with little or no reason for the operator to be within or proximate the defined zone of operation. Such task-based designs contribute to the limited functionality and use capabilities of many lift and/or transport assistance systems when it comes to meeting a large percentage of logistics and other such needs, and for at least partially bridging problematic “lift gaps.”

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a side view of a mobile robotic lift assistance system in accordance with one exemplary embodiment of the present invention;

FIG. 2 illustrates a front view of the mobile robotic lift assistance system of FIG. 1 in operation lifting various payloads and placing these on a transport vehicle;

FIG. 3 illustrates a perspective view of a mobile robotic lift assistance system in accordance with another exemplary embodiment of the present invention, the mobile robotic lift assistance system having a master control system and a slave system, the master control system comprising first and second master control arms that operate to control, respectively, first and second multi-degree of freedom robotic arms of the slave system;

FIG. 4 illustrates a detailed perspective view of the first robotic arm of the mobile lift assistance system of claim FIG. 3;

FIG. 5 illustrates a detailed, partial perspective view of the first robotic arm of the mobile robotic lift assistance system of FIG. 3, and a control interface system operable therewith formed in accordance with one exemplary embodiment of the present invention;

FIG. 6 illustrates a partially exploded detailed, partial perspective view of the first robotic arm of the mobile robotic lift assistance system of FIG. 3, and a control interface system operable therewith formed in accordance with another exemplary embodiment of the present invention;

FIG. 7 illustrates an end view of the partially shown first robotic arm and associated control interface system of FIG. 6, as taken along A-A;

FIG. 8 illustrates a graphical representation of a robotic arm and an associated control interface system in accordance with another exemplary embodiment of the present invention;

FIG. 9 illustrates a detailed, partial end view of the first robotic arm of the mobile robotic lift assistance system of FIG. 3, and a control interface system operable therewith formed in accordance with still another exemplary embodiment of the present invention; the control interface system comprising an exemplary end effector control system; and

FIG. 10 illustrates a graphical representation of an exemplary operator control module for a mobile robotic lift assistance system.

### DETAILED DESCRIPTION

The present invention is related to copending nonprovisional U.S. patent application Ser. Nos. ______, filed ______, 2011, and entitled, “Teleoperated Robotic System” (Attorney Docket No. 2865-20110418.1.NP); ______, filed ______, 2011, and entitled, “System and Method for Controlling a Tele-Operated Robotic Agile Lift System” (Attorney Docket No. 2865-20110418.2.NP); ______, filed ______, 2011, and entitled, “Platform Perturbation Compensation” (Attorney Docket No. 2865-20110418.3.NP); ______, filed ______, 2011, and entitled, “Multi-degree of Freedom Torso Support for Teleoperated Robotic Agile” (Attorney Docket No. 2865-20110418.5.NP); ______, filed ______, 2011, and entitled, “Variable Strength Magnetic End Effector for Lift Systems” (Attorney Docket No. 2865-20110418.6.NP), each of which are incorporated by reference in their entirety herein.

As used herein, the singular forms “a,” and, “the” include plural referents unless the context clearly dictates otherwise. Thus, for example, reference to “a robotic arm” includes one or more of such robotic arms and reference to a “degree of freedom” (DOF) includes reference to one or more of such DOFs (degrees of freedom).

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference will now be made to certain examples, and specific language will be used herein to describe the same. Examples discussed herein set forth a mobile robotic lift assistance system that can accommodate and provide for operator manipulation and control of a robotic arm and associated end effector locally from and via the robotic arm, and within a zone of operation. In particular examples, the mobile robotic lift assistance system can include one or more robotic arms having an associated control interface system operable therefrom, wherein the operator enters the zone of operation and engages the control interface system to manipulate and control the robotic arm, any end effector associated therewith, and optionally the mobile platform unit, the control interface system facilitating extremity control of the mobile robotic lift assistance system.

Specifically, a mobile robotic lift assistance system can comprise a mobile platform unit maneuverable about a ground surface and within an operating environment; a multi-degree of freedom robotic arm that operates to provide a lift function in relation to a payload as directed by an operator, said robotic arm comprising a mounting end operatively supported about said mobile platform unit, and a working end positionable in three-dimensional space within a zone of operation; an end effector operatively coupled to said working end of said robotic arm, that acts on said payload to perform an intended work function as directed by the operator; and an extremity control system located about said robotic arm that facilitates extremity control of said mobile robotic lift assistance system to lift and manipulate said payload, wherein said robotic arm and said end effector are each controlled locally by said operator at said robotic arm. The lift assistance system can comprise a gravity compensation mode, wherein the robotic arm and the end effector are gravity compensated in said three-dimensional space.

In another example, a method for controlling a mobile robotic lift assistance system can comprise obtaining a robotic arm as part of a mobile robotic lift assistance system; interfacing directly with the robotic arm through an extremity control system comprising a control interface device supported about the robotic arm; and manipulating the control interface device to command and control one or more functions of the mobile robotic lift assistance system, and at least a movement of the robotic arm and an end effector operation.

With these general examples set forth above, it is noted in the present disclosure that when describing the mobile robotic lift assistance system, or the various related systems or the method, each of these descriptions are considered applicable to the other, whether or not they are explicitly discussed in the context of that embodiment. For example, in discussing the mobile robotic lift assistance system per se, the various additional system and/or method embodiments are also included in such discussions, and vice versa.

Furthermore, various modifications and combinations can be derived from the present disclosure and illustrations, and as such, the following figures should not be considered limiting.

The term “zone of operation” shall be intended to mean generally the zone in which the lifting and moving of objects occurs, and in the case of the present invention mobile robotic lift assistance system shall also be intended to mean the zone of space reachable by the one or more robotic arms and any associated end effector with the mobile platform unit in a static, non-moving condition.

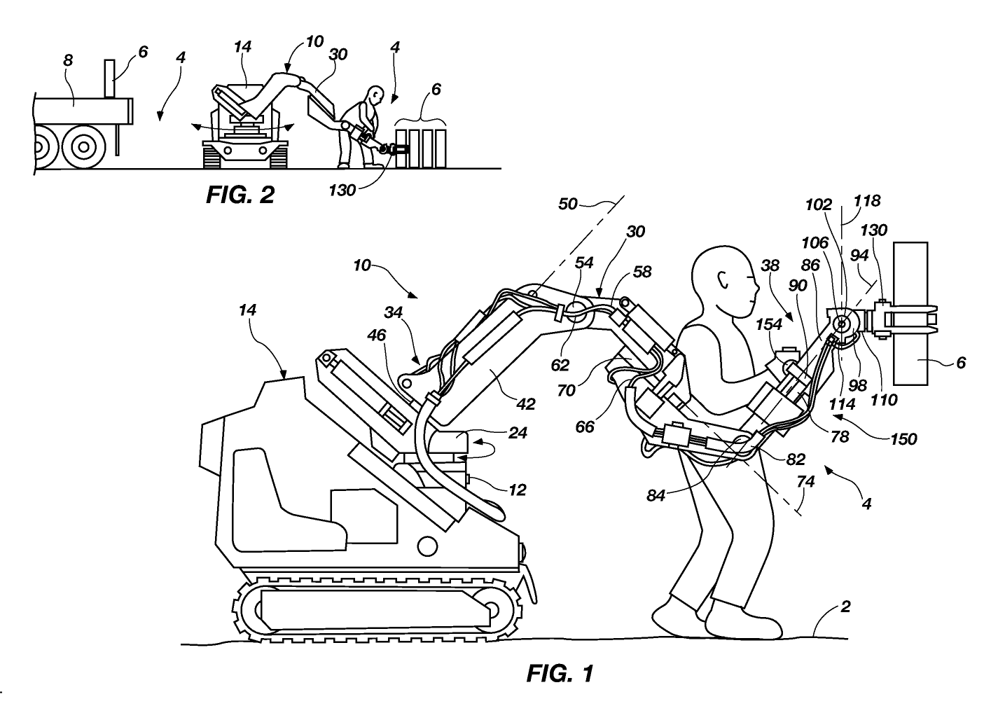

Illustrated in FIG. 1 is a mobile robotic lift assistance system in accordance with one exemplary embodiment of the present invention. The mobile robotic lift assistance system 10 is shown as comprising a mobile platform unit 14 capable of powered locomotion for traversing about a variety of different types of ground surfaces. In the embodiment shown, the mobile platform unit 14 comprises a dedicated vehicle having an endless or continuous track design. In other embodiments, the dedicated vehicle can comprise wheels (e.g., fixed-direction, steerable wheels, or omni-directional wheels), or a combination of these. In still other embodiments, the mobile platform unit 14 can comprise a different mobile vehicle type altogether, such as a truck, a ship, a train, etc.

The mobile platform unit 14 can be designed to be selectively operated or controlled by an operator, and can be configured to be maneuverable about a ground surface 2 and within an operating environment or zone of operation 4 to assist the operator in manipulating a payload 6. The mobile platform unit 14 is configured to assist the operator in approaching or advancing toward the payload 6 to be secured and hoisted or lifted by the mobile robotic lift assistance system 10. In addition, the mobile platform unit 14 can facilitate moving or translating the payload 6 from one location to another by being caused to traverse in one or more various directions about the ground surface 2. Indeed, once the payload 6 is secured by the mobile robotic lift assistance system 10, the mobile platform unit 14 functions to facilitate the transporting of the payload 6 from one location to another with ease and efficiency.

In another aspect (not shown), the mobile robotic lift assistance system 10 may comprise a fixed or permanent platform not intended to provide a mobility function to the system. Although not discussed in detail herein, such fixed platforms are contemplated, and therefore the mobile platform unit 14 should not be construed as limiting in any way.

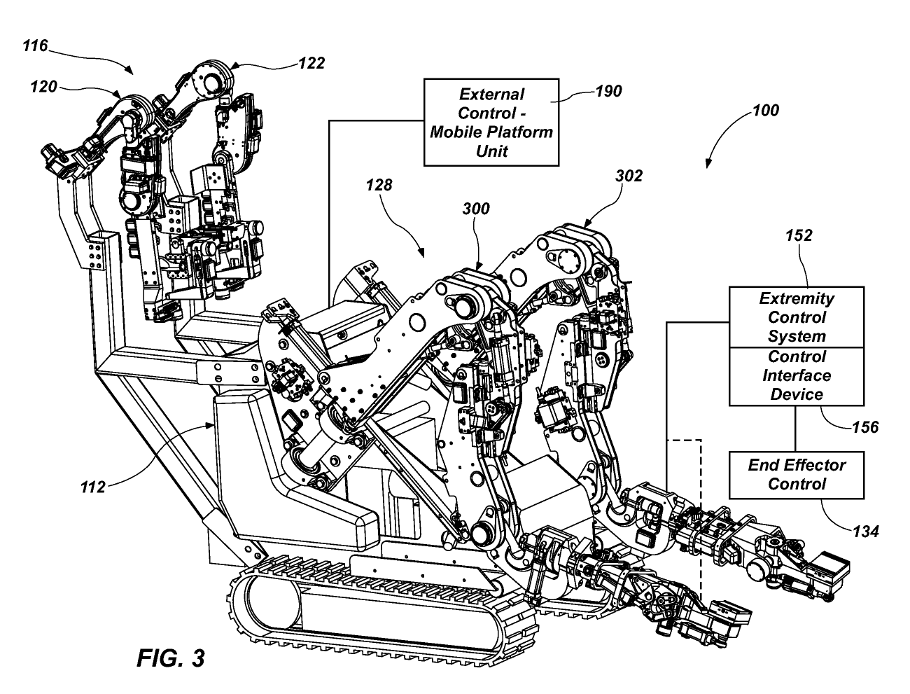

Referring back to FIG. 1, the mobile robotic lift assistance system 10 is shown as further comprising one or more multi-degree of freedom robotic arms (see robotic arm 30) that operate to provide a lift and/or translation function in relation to a payload 6 and within a zone of operation 4, as directed by an operator, or as commanded by a computer program. In the embodiment shown, the robotic arm 30 is supported about the mobile platform unit 14 via a pedestal or torso 24 that can comprise a swiveling or pivoting function, a tilting function, a telescoping function, etc. to impart one or more additional degrees of freedom to the system to enhance the capabilities of the robotic arm 30 (e.g., expand the zone of operation of the system, and the reach of the robotic arm 30). Details of an exemplary mobile platform unit having a similar pedestal or torso as the one discussed above are described and shown in copending U.S. patent application Ser. No. ______, filed ______, 2011, and entitled, “Multi-degree of Freedom Torso Support for Teleoperated Robotic Agile” (Attorney Docket No. 2865-20110418.5.NP), which is incorporated by reference in its entirety herein. In another exemplary embodiment, the robotic arm 30 may be secured directly to a frame component of the mobile platform unit 14 (for example, see the configuration of the lift assistance system 100 illustrated in FIG. 3 and the corresponding description).

The robotic arm 30 comprises a mounting end 34 operatively supported about the mobile platform unit 14 (which can be via the pedestal 24), and a working end 38 (free end) positionable in three-dimensional space within the zone of operation 4 and about the mobile platform unit 14. The mobile platform unit 14 functions as the base structure configured to support itself and the one or more robotic arms 30, and to facilitate the lifting of various types of payloads 6 by the robotic arm 30, the translation of these about and within the zone of operation 4, and the movement of the system (with or without the payload 6) from one location to another along a ground surface 2.

The robotic arm 30 can further comprise a multiple degree of freedom arrangement. In the embodiment shown, the robotic arm 30 comprises a seven degree of freedom arrangement, with corresponding linkages and joints. A first support member 42 is rotatably coupled to the pedestal or torso 24 of the mobile platform unit 14 at joint 46, which enables rotation about axis 50. The first support member 42 can extend from the mobile platform unit 14 to a second support member 58, which may be pivotally coupled together by a joint 54. The first and second support members 42 and 58 pivot about one another at the joint 54 about an axis 62 (extending in and out of the page), which corresponds to a flex/extend motion of the human shoulder.

The second support member 58 extends from the joint 54 and is coupled to a third support member 66 by joint 70, which forms axis 74. Second and third support members 58 and 66 rotate relative to one another about axis 74. Joint 70 provides a rotational DOF about axis 74 corresponding to humeral rotation of the human shoulder. Thus, the robotic arm 30 can include three separate joints that correspond to the single joint of the human shoulder.

The second support member 58 and the third support member 66 combine to form a linkage between joint 54 and a joint 84. The third support member 66 is coupled to a fourth support member 78 at the joint 84, which forms axis 82 (extending in and out of the page). The third and fourth support members 66 and 78 pivot relative to one another at the joint 84, and about axis 82. Joint 84 provides a rotational DOF about axis 82 corresponding to a human elbow.

The fourth support member 78 is coupled to a fifth support member 86 at joint 90, which forms axis 94. Joint 90 provides a rotational DOF about axis 94, which corresponds to human wrist rotation. The fifth support member 86 is coupled to a sixth support member 98 (hidden from view in the figure) at joint 102, which forms axis 106 (extending in and out of the page). Joint 102 provides a rotational DOF about axis 106 corresponding to human wrist abduction/adduction. The sixth support member 98 is coupled to a seventh support member 110 at joint 114 (hidden from view in the figure), which forms axis 118. Joint 114 provides a rotational DOF about axis 118, which corresponds to human wrist flex/extend.

Of course, a robotic arm with fewer or greater linkages, joints and associated degrees of freedom is entirely possible and contemplated to be within the scope of the present invention as described herein. As such, the robotic arms described herein are not meant to be limiting in any way.

Coupled to the working end 38 of, and operatively supported by, the robotic arm 30, and particularly to the wrist-like arrangement provided or defined by the fourth, fifth, sixth and seventh support members 78, 86, 98, and 110, respectively, and the associated joints resulting from the connection or coupling of these, is an end effector 130. The end effector 130 is operatively coupled to the seventh support member 110, and is configured to perform one or more working functions as supported about the robotic arm 30. The mobile robotic lift assistance system 10 may comprise a plurality of end effectors as needed or desired. In one aspect, the robotic arm 30 may be configured to operatively support a plurality of end effectors. In another aspect, the mobile robotic lift assistance system 10 may comprise a plurality of robotic arms, each operatively supporting a single end effector.

In one aspect, a working function may include, but is not limited to, acting on the payload to lift and/or transport the payload. In another aspect, a working function may include an action to be carried out other than lifting or transporting, such as welding, scanning, cutting, etc. In these cases, an appropriate end effector may be utilized that is sufficiently configured to carry out such task or combination of tasks. As such, it is contemplated herein that the end effector 130 may comprise a variety of types depending upon the desired operation or function to be performed. For example, the end effector 130 may comprise a grasping device, a clamping device, a spreader or spreading device, a welding device, a cutting device, a scanning device, a surveillance device, a magnetic lifting device, a pneumatic hammering device, a compacting device, a winching device, a claw or hand-like device having one or more finger-like extensions, a measuring device, a detection device (e.g., radiation detection, chemical detection, etc.), and any combination of these. Of course, these are not meant to be limiting in any way as other end effector types not specifically listed are contemplated herein.

Various embodiments and implementations are also contemplated herein where the end effector 130 is removably coupled to the robotic arm 30, and interchangeable with different types of end effectors.

The mobile robotic lift assistance system 10 is shown as further comprising an extremity control system 150 that facilitates operator command and control over one or more functions of the mobile robotic lift assistance system 10, and at least over the movement and manipulation of the robotic arm(s) 30 and the end effector 130, by providing an operator interface directly with the robotic arm 30. The extremity control system 150 comprises a control interface device 154 located about the robotic arm 30, that is configured to interface with the hand and/or arm of the operator to assist the operator to move and manipulate the robotic arm 30 and end effector 130 (and any payload), as well as to control the operation of the end effector 130, locally (i.e., directly from or about the robotic arm 30). It is noted that an operator may apply a force directly to the robotic arm to manipulate and move the robotic arm without using a control interface device. Moreover, as shown, the extremity control system 150 allows the operator to be within the zone of operation 4, as desired, and to operate the mobile robotic lift assistance system 10 from within this zone.

In the specific embodiment shown, the control interface device 154 is operatively coupled to the fourth support member 78, and comprises a handle or other similar device that the operator can grasp and hold onto in a suitable manner so as to be able to manipulate and move the robotic arm 30 and the end effector 130 (and any payload) within three-dimensional space. The control interface device 154 is located on an inner side of the robotic arm 30, thus also placing the operator on the inner side of the robotic arm 30, wherein the operator's right hand or arm is intended to interface with the control interface device 154. However, as will be shown below, the control interface device may comprise any number of suitable devices, and may be located at different locations along the robotic arm 30.

With reference to FIGS. 1 and 2, the mobile robotic lift assistance system 10 is designed to operate to lift one or more payloads 6, and to translate this within the zone of operation 4 as needed (e.g., to support and secure the payload 6, and relocate it to a new position). However, unlike conventional lift assistance systems, the mobile robotic lift assistance system 10 provides an operator with the ability to “step into” the zone of operation 4, to easily and selectively interface directly with the robotic arm 30 without being strapped or otherwise secured to the robotic arm 30, and to harmoniously interact with and manipulate the robotic arm 30. By moving his body, and particularly his arm, the operator essentially commands the robotic arm 30 to move in a coordinated fashion. By interfacing with the control interface device 154, the operator is able to selectively and strategically position the robotic arm 30 into any available position within its reach, only being limited by things such as the operator's reach and any present environmental conditions, and thus strategically position the end effector 130 at an appropriate position for carrying out an intended work function.

In the example shown, in operation the operator approaches and enters the zone of operation 4, approaches the robotic arm 30, grasps or otherwise interfaces with the control interface device 154 and then begins to control the movements of the robotic arm 30. In order to perform a task, such as loading a collection of payload items into the back of a truck, the operator may cause the robotic arm 30 and end effector 130 to move into a position about a payload 6. Once the end effector is in position to reach the payload 6, the operator may then initiate a command to cause the end effector to perform a function. In this case, the operator would cause the end effector 130, in the form of a clamp or gripper, to open. Once in the open position, the operator may then move the robotic arm and/or the mobile platform unit as needed toward the payload 6 to properly place the payload 6 within the gripper, at which time the operator may cause the gripper to close around the payload 6, thus grasping the payload 6 and securing it to or within the end effector 130. The operator may then again move the robotic arm 30 to lift and/or translate the payload 6 within the zone of operation. Once secured and lifted, the operator may move towards a desired location where the payload 6 will be released. In this case, the operator would walk around the mobile platform unit 14 towards a transport vehicle 8, which is shown as comprising a truck with an open truck bed, and unload the payload 6 on the truck bed. As the operator moves about the ground surface 2, the robotic arm would be caused to essentially go where he goes, and to respond to his movements as conveyed to the robotic arm 30 (and the end effector 130) through the control interface device 154. Thus, as the operator walks toward the transport vehicle 8 from the position of picking up the payload 6, pushing on the robotic arm 30 would cause the robotic arm 30 to move. The robotic arm 30 would respond to his movements through the control interface device 154 (and to his walking), wherein the various support members and joints would move in response to the operators movements. In addition, the pedestal or torso 24 on the mobile platform unit 14 may also be caused to rotate as the operator walks around the mobile platform unit 14 toward the transport vehicle 8. Still further, if the operator desired to carry the payload to another location, the operator may cause the mobile platform to move about the ground surface as needed. The mobile platform may be caused to move using a remote control unit, or upon entering a “follow-me” mode, each of which will be described in more detail below.

The mobile robotic lift assistance system 10 may comprise any number of control interface devices. In addition, these may be located at any position or region along the robotic arm 30 as needed or desired. In one aspect, the control interface device 154 may be located at a more distal position along the robotic arm 30 to take advantage of the mechanical advantages realized the further down the robotic arm 30, and away from the mounting point about the mobile platform unit 14, the control interface device 154 is placed. Placing the control interface device in a distal region will help to reduce the loads required to be exerted on the robotic arm 30 by the user to move it within the zone of operation 4, leading to less resistance and fatigue felt by the operator during operation, and particularly during extended times of operation. Of course, other locations for control interface devices are contemplated herein, and may be provided as needed or desired.

The mobile robotic lift assistance system 10 provides a very intuitive system that is simple for an operator to use and control due to the fact that the loads felt by the operator can be limited, thus allowing the operator to react to the loads and manipulate the robotic arm 30 in a natural way, and thus allowing the robotic arm 30 to be used as a high fidelity, dexterous manipulator in a complex environment. For example, if the robotic arm 30 comes into contact with a surface or an object, the user can feel the contact and respond accordingly, much in the same way he/she would if coming into contact with the surface or object with their own hand or arm. The system facilitates an intuitive, natural response of the operator to an expected or even unexpected event to move the robotic arm 30 in a desired direction within the operator's natural range of motion or with a reflexive reaction. For example, when a person bumps his or her arm into a surface the natural reflexive reaction is to move the person's arm away from the surface. A similar reaction is made possible with using the extremity control system taught herein.

The ability to provide extremity control of the robotic arm 30 is significantly enhanced through the use of gravity compensation of the robotic arm 30. A relatively long robotic arm, such as 4 to 10 feet (1.2 to 3.1 meters) in length, can weigh several hundreds of pounds (or kilograms). When the robotic arm 30 is used to pick up objects that weigh less than the robotic arm 30, the change in mass of the robotic arm 30 and payload combination is relatively small, relative to an unloaded arm.

Gravity compensation involves measuring the effects of gravity on each support member in the robotic arm 30 and adjusting the torque at each DOF to compensate for the effects of gravity. In one embodiment, each support member can include a separate measurement device that is used to determine the direction of the gravitational pull (i.e. the gravity vector) relative to a center of gravity of the respective support members. Alternatively, a single measurement may be taken with respect to a fixed frame of reference for the robotic arm, such as the base on which the arm is located. A transformation of the frame of reference can then be calculated for each support member and a determination can be made as to the level of torque needed at each DOF to compensate for the gravitational pull based on the position, center of gravity, and mass of the support member.

In one embodiment, a single measurement of the gravity vector with respect to a fixed location relative to the robotic arm can be acquired using a gravity sensor (see gravity sensor 12) such as an inertial measurement unit. In a multi-axis system, such as the robotic arm 30 having seven different support members 42, 58, 66, 78, 86, 98, and 110, the load and torque at each of the respective joints 46, 54, 70, 84, 90, 102, and 114 that is caused by gravity acting on each member can be calculated.

For example, a determination of the torque caused by the gravitational force at each joint 46, 54, 70, 84, 90, 102, and 114 coupled to the support members 42, 58, 66, 78, 86, 98, and 110 can be determined using the Iterative Newton-Euler Dynamic Formulation. The velocity and acceleration of each support member can be iteratively computed from the first support member 42 (axis 50) to the last or seventh support member 110 (axis 118). The Newton-Euler equations can be applied to each support member. The forces and torques of iteration and the joint actuator torques can then be computed recursively from the last support member back to the first support member based on a knowledge of the mass of each segment, its center of gravity, and its position. The position of each support member can be determined using a position sensor such as an encoder. The effect of gravity loading on the segments can be included by setting the velocity equal to the gravity vector measured by the inertial measurement unit.

While the Iterative Newton-Euler Dynamic Formulation has been provided as one example of gravity compensation, it is not intended to be limiting. Indeed, there are a number of different ways to incorporate gravity compensation in a robotic system. Any gravity compensation scheme that can be used to calculate torque values that can be used to compensate for the effects of gravity on the robotic arm is considered to be within the scope of the present invention.

Once the amount of force caused by the measured gravitational vector is calculated at each joint 46, 54, 70, 84, 90, 102, and 114, the force can be compensated for by applying an opposite force to effectively compensate for the force of gravity. The opposite force may be applied using an electric motor connected to each joint, or through the use of pneumatic or hydraulic valves connected to actuators, as discussed below. The same gravity sensor 12 can be used to compensate two or more robotic arms (see the first and second robotic arms 300 and 302 illustrated in FIG. 3).

Gravity compensating the robotic arm can allow an operator to utilize the extremity control system 150 to manipulate and control the robotic arm 30 for extended periods, with fatigue being limited.

Moreover, the robotic arm 30 can be configured to also compensate for the weight of the operator's arm. For instance, to obtain the desired movement of the robotic arm while unloading a shipment of 200 pound (90.7 kg) objects from a shipping truck, the operator's arm may be extended for a significant length of time. The angle of extension of the operator's arm may cause the operator to fatigue. To enable the operator to control the robotic arm 30 for extended periods, the robotic arm 30 can be configured to support the weight of the operator's arm, allowing the operator to manipulate the robotic arm 30 while minimizing the use of effort needed to extend the operator's arm.

With reference to FIG. 3, illustrated is a mobile robotic lift assistance system formed in accordance with another exemplary embodiment. In this embodiment, the mobile robotic lift assistance system 100 comprises a teleoperated robotic lift system, having a platform 112, a master control system 116 comprising first and second master control arms 120 and 122, respectively, and a slave system 128 comprising first and second robotic slave arms 300 and 302, respectively, which each can be controlled and manipulated by an operator using the first and second master control arms 120 and 122, respectively, of the master control system 116. Additional details of a similar teleoperated robotic lift system are provided in copending application Ser. Nos. ______, filed on ______, 2011, and entitled, “Teleoperated Robotic Agile Lift System” (Attorney Docket No. 2865-20110418.1.NP), and ______, filed on ______, 2011, and entitled, “Control Logic for Teleoperated Robotic Agile Lift System” (Attorney Docket No. 2865-20110418.2.NP), which applications are herein incorporated by reference in their entireties.

The mobile robotic lift assistance system 100 further comprises, as generically shown, an extremity control system 152 having a control interface device 156, an end effector control 134, and an optional external control 190 for facilitating external operator control of the mobile platform unit. Each of these systems and devices will be described in additional detail below.

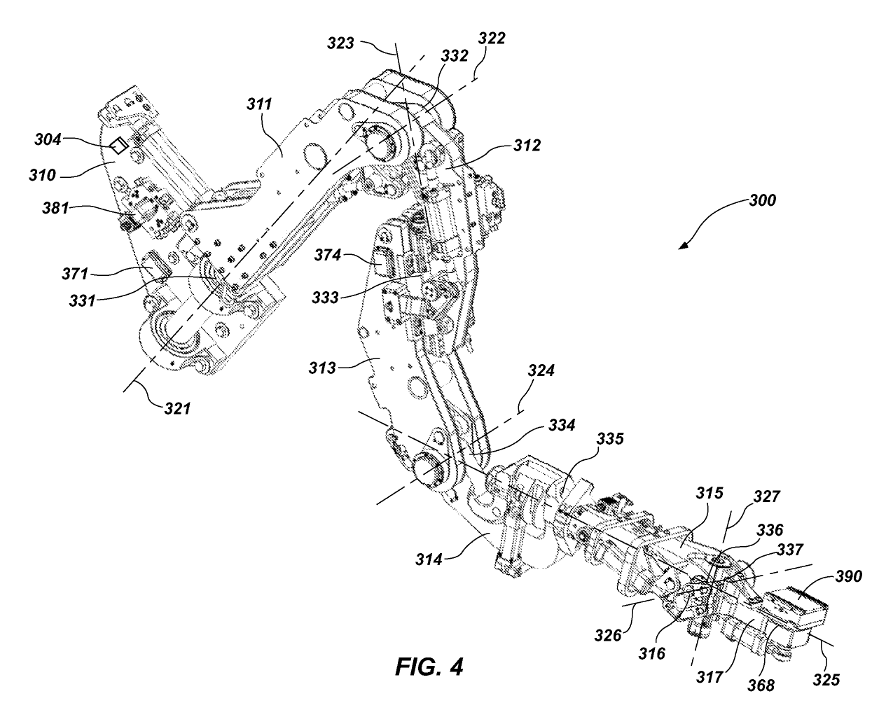

Referring to FIG. 4, illustrated is the first robotic slave arm 300 of the robotic lift assistance system 100 of FIG. 3. For simplicity, the slave arm 300 is shown independent of other components of the robotic system, such as master control arms 120, 122, slave arm 302, platform 112, and a control interface device. The slave arm 300 can be mounted, installed, or otherwise associated with any platform capable of supporting the robotic slave arm. Typically, the slave arm is supported by the platform in a manner that allows the slave arm to interact with objects in a zone of operation.

The slave arm 300 can be configured as a kinematic system to include DOF and linkages that correspond to the DOF and linkages of the master control arm 120 and a human arm from the shoulder to the wrist. In one aspect, the lengths of the linkages of the slave arm are proportional to corresponding linkage lengths of the master control arm.

In general, the master control arm is configured to interface with a human user, thus certain of the structural features and characteristics may be the result of this objective. In some cases, remnants of these structural features and characteristics may be carried over and incorporated into the slave arm. For example, as shown in FIG. 4, axis 321 is at about a 45 degree angle relative to a horizontal plane. This configuration may not be necessary for a functional slave arm but it is similar to that of the master control arm. In other cases, some structural features and characteristics of the master control arm that facilitate the human interface may not be incorporated into the slave arm. For example, the slave arm can operate effectively without incorporating the structure of the master control arm corresponding to the user's wrist DOF. Such structure could unnecessarily inhibit or constrain operation of the slave arm. Thus, in some instances, the structure and apparatus of the slave arm may be more simplified or more closely replicate a human arm, than corresponding structure of the master control arm. In various embodiments, a slave arm can include greater than or less than seven DOF.

As illustrated in FIG. 4, a first support member 311 is coupled to base 310 at joint 331, which enables rotation about axis 321. The DOF about axis 321 represents a rotational DOF corresponding to a first DOF of the master control arm and abduction/adduction of the human shoulder. A first support member 311 can extend from the base 310 to position joint 332 proportional to corresponding features of the master control arm. Joint 332 is coupled to a second support member 312 and forms axis 322. The DOF about axis 322 represents a rotational DOF corresponding to a second DOF of the master control arm and flex/extend of the human shoulder.

The second support member 312 extends from the joint 332 and is coupled to a third support member 313 by joint 333, which forms axis 323. The DOF about axis 323 represents a rotational DOF corresponding to a third DOF of the master control arm and humeral rotation of the human shoulder. Thus, the slave arm can include three separate joints that correspond to three DOF of the master control arm, which can correspond to the single joint of the human shoulder.

The second support member 312 and the third support member 313 combine to form a linkage disposed between joint 332 and joint 334 that corresponds to a similar linkage of the master control arm and to the human upper arm between the shoulder and the elbow. The third support member 313 is coupled to a fourth support member 314 by joint 334, which forms axis 324. The DOF about axis 324 represents a rotational DOF corresponding to a fourth DOF of the master control arm and a human elbow.

The fourth support member 314 is coupled to a fifth support member 315 at joint 335, which forms axis 325. The DOF about axis 325 represents a rotational DOF corresponding to a fifth DOF of the master control arm and human wrist rotation. The fifth support member 315 is coupled to a sixth support member 316 at joint 336, which forms axis 326. The DOF about axis 326 represents a rotational DOF corresponding to a sixth DOF of the master control arm and human wrist abduction/adduction. The sixth support member 316 is coupled to a seventh support member 317 at joint 337, which forms axis 327. The DOF about axis 327 represents a rotational DOF corresponding to a seventh DOF of the master control arm and human wrist flex/extend.

In one aspect, the DOF structure of the slave arm closely resembles the DOF of the human wrist. For example, the DOF about axis 325 is similar to a human wrist in that the DOF structure is located in the “forearm” of the slave arm. Likewise, the DOF about axes 326, 327 of the slave arm is similar to a human wrist in that the DOF structure is located in the “wrist” of the slave arm. Thus, structure forming axes 325, 326, 327 of the slave arm can closely resemble a human wrist.

The slave arm can include actuators, which are associated with the DOF of the slave arm. The actuators can be used to cause rotation about a given DOF axis of the slave arm based on a change of position of the master control arm. The actuators can also be used to enable gravity compensation of the slave arm. In one aspect, there is one actuator for each DOF of the slave arm. The actuators can be linear actuators, rotary actuators, etc. The actuators can be operated by electricity, hydraulics, pneumatics, etc. The actuators in the slave arm depicted in FIG. 4, for example, are hydraulic linear actuators. The actuators may be operated through the use of a hydraulic pump, such as that manufactured by Parker, and having a Model No. P/N PVP1630B2RMP.

Each actuator may be controlled using an electric motor. Alternatively, hydraulic or pneumatic servo valves, such as servo valve 381 shown in FIG. 4, can be opened or closed to enable a selected amount of hydraulic or pneumatic fluid to apply a desired level of force to the actuator to apply a torque to the corresponding joint. Servo valves can be fluidly coupled to actuators of the slave arm. In one example, a servo valve can be associated with each actuator, enabling a port to open to cause a desired force to be applied by the actuator in a selected direction. Another port can be opened to apply force in the opposite direction. One type of servo valve that can be used is manufactured by Vickers under part number SM4-10(5)19-200/20-10S39. Another type of servo valve that can be used is manufactured by Moog, model 30-400A. Additional types of servo valves may be used based on design considerations including the type of valve, the pressure at the valve, and so forth.

The slave arm can include position sensors, which are associated with the DOF of the slave arm. In one aspect, there is one position sensor for each DOF. The position sensors can be located, for example, at each of the joints 331, 332, 333, 334, 335, 336, and 337. Because the DOF of the slave arm at these joints are rotational, the position sensors can be configured to measure angular position.

In one aspect, the position sensors can detect a change in position of the slave arm at each DOF, such as when the actuators cause rotation about the DOF axes. When the position of the slave arm about the slave arm DOF axes reaches a position proportional to a position of the master control arm at the corresponding DOF axes, the actuators cease causing movement of the slave arm. In this way, the position of the master control arm can be proportionally matched by the slave arm.

The position sensor can be an absolute position sensor that enables the absolute position of each joint to be determined at any time. Alternatively, the position sensor may be a relative position sensor. The position sensors can include any type of suitable position sensor for measuring a rotation of each joint, including but not limited to an encoder, a rotary potentiometer, and other types of rotary position sensors. One example of a position sensor that can be used is an encoder disk produced by Gurley Precision Instrument, Manufacturer P/N AX09178. The encoder disk can be coupled to each joint 331-337 in the slave arm. An encoder reader produced by Gurley Precision Instrument, P/N 7700A01024R12U0130N can be used to read the encoder disk to provide an absolute position reading at each joint.

The slave arm can also include load sensors, which are associated with the DOF of the slave arm. The load sensors can be used to measure loads in the slave arm, which can be proportionally reproduced by the actuators of the master control arm. In other words, a load in the slave arm can cause a corresponding load to be exerted within the master control arm. In this way, loads “felt” at the slave arm can be transmitted to the master control arm and, thus felt by the user. This force reflection aspect thus includes the slave arm controlling the master control arm via the load commands. The load sensors can also be used to enable gravity compensation of the slave arm. In addition, the load sensors can be used to measure a force applied by a user to the slave arm to enable enhanced operation of the slave arm, such as by torque assistance. The load sensors can include any type of suitable load sensor including, but not limited to, a strain gauge, a thin film sensor, a piezoelectric sensor, a resistive load sensor, and the like. For example, load sensors that may be used include load cells produced by Sensotec, P/N AL311CR or P/N AL31DR-1A-2U-6E-15C, Futek, P/N LCM375-FSSH00675, or P/N LCM325-FSH00672.

In one aspect, there is one load sensor for each DOF of the slave arm. In another aspect, several DOF of the slave arm can be accounted for with a multi DOF load sensor strategically located about the slave arm. For example, a multi DOF load sensor capable of measuring load in at least four DOF could be associated with axis 324, which corresponds to the elbow DOF of the user. Additionally, single or multi DOF load sensors can be associated in any combination with axes 325, 326, 327, which correspond to the wrist DOF of the user. Data from the multi DOF load sensors can be used to calculate the load at a DOF between the load sensor location and the base 310.

The load sensors can be located, for example, at each support member of the slave arm. In one aspect, the load sensors can be associated with the actuators. As with the master control arm, the load sensors of the slave arm can include any type of suitable load sensor.

Additionally, load sensors can be located at other locations on the slave arm. For example, a load sensor 368 can be located on seventh support member 317. Load sensor 368 can be configured to measure loads acting on the seventh support member 317 through end effector 390. Load sensor 368 can be configured to measure load in at least one DOF, and in one aspect, is a multi DOF load sensor. End effector 390 can be located at an extremity of the slave arm and can be configured to serve a variety of uses. For example, the end effector can be configured to secure a payload for manipulation by the slave arm. Thus, load sensor 368 can measure loads imparted by the payload and the end effector on the seventh support member 317. Load data acquired at the end effector can be used to enhance the ability of the slave arm to support and maneuver the end effector and payload.

In another example, discussed further below, a load sensor can be included on a slave arm, such as with a control interface device 154, to enhance the ability of the user to manipulate and maneuver the slave arm when interacting with the slave arm in the zone of operation. For example, torque assistance can be provided based on data gathered from such a load sensor, which can be used to assist the user in moving the slave arm. The torque assistance can also help the user to overcome inertial forces when accelerating and decelerating the slave arm. Moving the slave arm while in the zone of operation may fatigue the user over time. With the torque assistance that is made possible through the use of a load sensor associated with the control interface device 154, the user can provide small amounts of force in a desired direction to move the salve arm in spite of the mass of the slave arm, the mass of a payload, inertial forces, frictional forces, and other forces that can cause movement of the slave arm to be resistive to the user. The amount of torque assistance can be adjusted to provide as little or as much torque assistance as desired by the user.

The slave arm 300 can also include a general DOF controller (GDC) associated with each DOF. In one example, a separate GDC, such as 371, 374 shown in FIG. 4, can be associated with each of the axes in the slave arm 300. The GDC can be in communication with the sensors, such as the load sensor and position sensor, located at each joint. The GDC can also be in communication with the actuator and/or servo valve at each joint. Each GDC can be used to monitor and adjust the position and torque at a selected joint on the slave arm 300. Additional inputs from other types of sensors may be received as well. The GDC at each axis can interact with an actuator or servo valve for the associated joint to adjust the torque at the joint and/or move the axis of the DOF by a predetermined amount.

In one example, the GDC for each DOF on the slave arm can comprise a computer card containing one or more microprocessors configured to communicate with the sensors and valves and to perform calculations used to control the movements of the slave arm. For instance, the GDC can include a general purpose central processing unit (CPU) such as an ARM processor, an Intel processor, or the like. Alternatively, a field programmable gate array (FPGA), application specific integrated circuit (ASIC) or other type of processor may be used. The GDC can communicate with the sensors using wired or wireless means.

The slave arm 300 can also include a gravity sensor 304 to determine the gravity vector, which can be used to enable gravity compensation of the slave arm. The gravity sensor can be associated with the slave arm, such that the gravity sensor and the base of the slave arm are fixed relative to one another. For example, the gravity sensor can be located on the base 310 of the slave arm or on a support for the base of the slave arm. In certain aspects, a gravity sensor can be located on each linkage or support member of the slave arm, such as at a center of gravity of the linkage or support member. The gravity sensor can include any type of suitable gravity sensor including, but not limited to, at least one of a tilt sensor, an accelerometer, a gyroscope, and an inertial measurement unit. For example, a gravity sensor produced by Microstrain, Inc., P/N 3DM-GX1-SK may be used.

In one aspect, the slave arm can be manually moved by a user by applying a pressure to the slave arm to move it in a desired direction. In certain situations, such as when attaching a missile to an underside of an aircraft wing, the user may desire to physically grasp and manually position the slave arm or payload to avoid the damaging effects of a potential errant movement of the slave arm. In this case, the force applied by the user can be detected at each joint 331-337 by the load sensors associated with the DOF at the joints and output as a slave arm torque value. The slave arm torque value can be communicated to a valve current control and used to apply a force, or torque assistance, to one or more of the actuators of the slave arm to move the slave arm in the desired direction, thereby assisting the user to move the slave arm. Such a torque assistance function can greatly enhance the user's ability to move the slave arm, especially when a heavy load is being lifted. Alternatively, force applied by the user may not initiate the torque assistance function associated with the slave arm. In this case, the user can still move the slave arm and payload by manual manipulation, but this would be without the benefit of torque assistance to lessen the force necessary to cause movement of the slave arm. The torque assistance function, while not being required to do so, is typically configured so as to cause movement of the slave arm in the direction of the applied load by the user. In one aspect, the amount of torque assistance provided can be tuned to enhance the “feel” of the slave arm during operation.

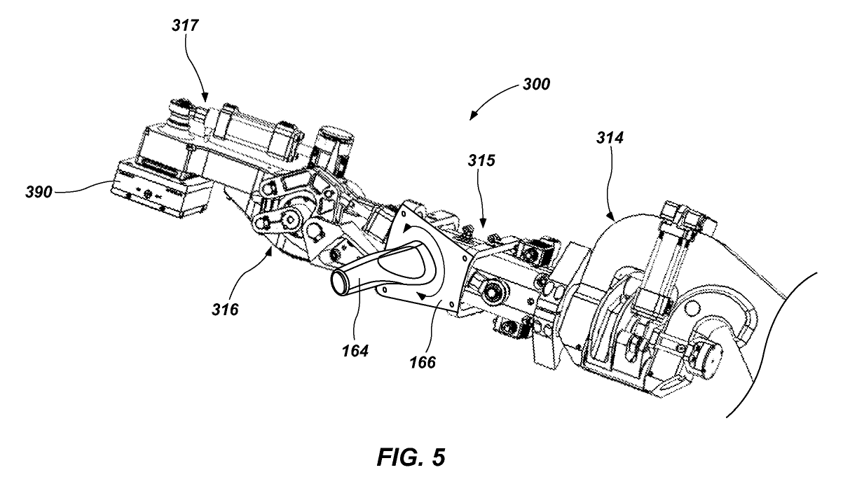

Referring to FIG. 5, and with continued reference to FIG. 4, illustrated is a portion of a slave arm 300 having a control interface device 164 in accordance with one exemplary embodiment, wherein the control interface device comprises a hand grip about a strategic location for the user to grasp when manually positioning the slave arm. The control interface device 164, or hand grip, can be coupled to a support member of the slave arm, such as the fifth support member 315, and disposed in a location that is convenient for the user to grasp. The control interface device 164 can be configured as a handle or other device suitable for grasping. The control interface device 164 can be coupled to a support member via a mounting plate 166, which can be adapted to couple to both the support member and the control interface device 164. With the control interface device 164, the user can cause rotation of the fifth support member 315 about axis 325 relative to the fourth support member 314. Additionally, the user can cause rotation about any or all of axes 324, 323, 322, and 321 of the slave arm back to the base 310 of the slave arm to manipulate and position the slave arm.

With the control interface device 164 coupled to the fifth support member 315, the user cannot cause rotation of the sixth or seventh support members about axes 326 and 327, respectively, merely by manipulating the control interface device 164. In this case, the user can grasp the support members themselves or the payload directly to cause rotation about axes 326, 327. As will be described below, other types of control interface devices are contemplated that do facilitate rotation of the sixth and/or seventh support members.

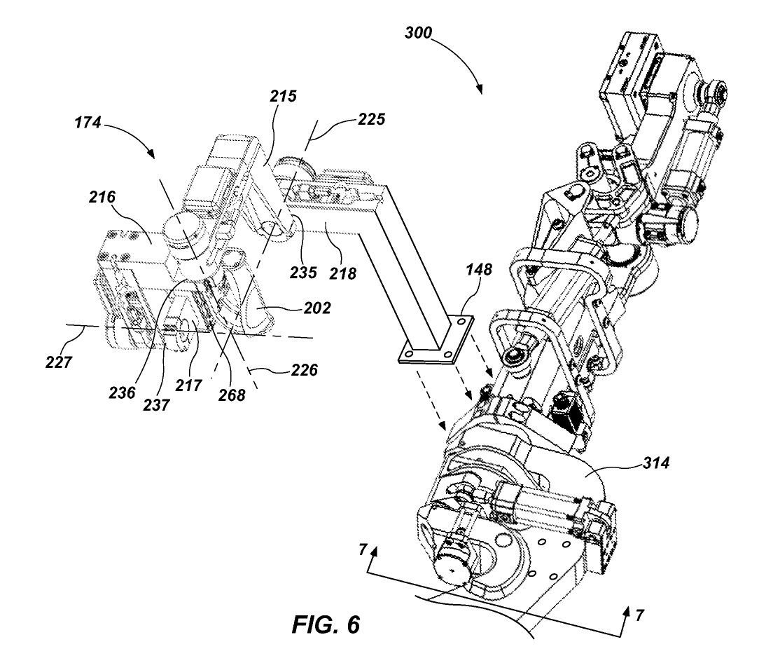

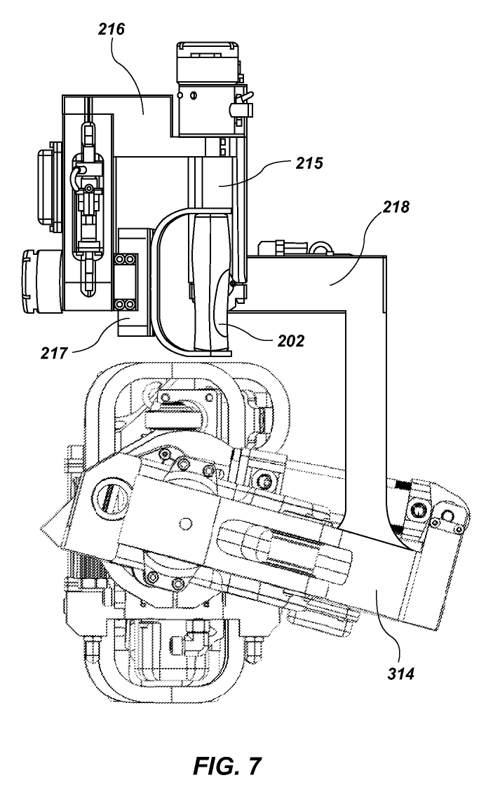

Referring to FIGS. 6 and 7, illustrated is a control interface device 174 in the form of a multi-degree of freedom gripper that can enable the user to control the DOF of the slave arm that are beyond the mounting location of the control interface device 174. For example, the control interface device 174 can have DOF associated with axes 225, 226, 227 and can be configured to provide the user with the ability to control the slave arm DOF, for example, associated with axes 325, 326, 327, respectively, with corresponding movements of the user's wrist. The control interface device 174 can be coupled to the fourth support member 314 of the slave arm 300.

The control interface device 174 and the slave arm can have several operating modes. One operating mode is position control. With position control, the positions of the various DOF of the control interface device 174 are used to control the position of the various DOF of the slave arm. The positional relation between the control interface device 174 and the slave arm can be a proportional relationship. In one aspect, the proportional position relationship between the control interface device 174 and the slave arm can be a one-to-one relationship where a control interface device 174 movement results in the same slave arm movement. This could be a useful general-purpose control setting. In another aspect, the proportional position relationship between the control interface device 174 and the slave arm can be a relationship where a large control interface device 174 movement results in a small slave arm movement. This could be useful when the user desires a precise movement or control over the slave arm. In still another aspect, the proportional position relationship between the control interface device 174 and the slave arm can be a relationship where a small control interface device 174 movement results in a large slave arm movement. This could be useful when the user desires a gross movement to rapidly move the slave arm without excess or unnecessary movement by the user. In this case, the control interface device 174 is coupled to the slave arm. Therefore, the control interface device 174 can teleoperate an extremity of a robotic arm of which it is a part.

In one aspect, the proportional relationships can be consistent or vary among the corresponding DOF of the control interface device 174 and the slave arm. In another aspect, the proportional relationships can be modified. For example, the user can alter the proportional positional relationships between the control interface device 174 and the slave arm DOF. In one aspect, the user can vary the proportional relationships with a manual control accessible while the user is operating the control interface device 174. In a specific aspect, the manual control can comprise a dial or button that is mounted on the control interface device 174 on or near the handle 202. In other examples, the manual control can be via a touch screen mounted near the operator or elsewhere on the system, or can be via an application on the operator's smart phone or other PDA device that wirelessly communicates with the system.

Another operating mode includes force reflection from the slave arm to the control interface device 174. With force reflection, the user is provided with an additional sensory input for operating the slave arms. Unlike positional control, where the slave arm will operate to carry out the positional command from the control interface device 174 regardless of obstacles that may be in the path of the slave arm, force reflection provides a proportional force feedback to the user via the control interface device 174 to indicate forces that the slave arm is experiencing. For example, if the slave arm encounters an obstacle while executing a positional command from the control interface device 174, a load sensor on the slave arm can send the force information to the control interface device 174, and the actuators of the control interface device 174 can apply a proportional force to the user. With this force feedback, the user can more intuitively control the slave arm in the operating environment because it more closely resembles the user's experience operating the user's own body in everyday life. In this case, the control interface device 174 is coupled to the slave arm. Therefore, the control interface device 174 can receive force reflection from a robotic arm of which it is a part.

In one aspect, the user can feel a force proportional to the weight of an object being picked up by the slave arm. For example, if an object weighs 500 pounds, the proportional force reflected load experienced by the user could be 10 pounds. In another aspect, when the slave arm encounters an object, the user feels the resistance of the object via the control interface device 174 and can take action to avoid or minimize harmful effects. Thus, force reflection can be a safety feature of the robotic system.

In certain aspects, force reflection can include an increased load produced by the control interface device 174 on the user when the slave arm experiences an impact event. In other words, an impact sensed by the load sensors can be reflected to the user via the control interface device 174 as a transient spike in force disproportionate to the normal proportional setting for force reflection. For example, when the slave arm collides with a wall, the load sensors of the slave arm sense the impact. To alert the user that an impact has occurred, the control interface device 174 can produce a force on the user that is disproportionately large relative to the current proportional force reflective setting for a brief period of time that can effectively represent the impact to the user. For example, the force on an impact could be so disproportionately large that no user would be able to move the master arm in such an impact, making it a hard stop to the user regardless of their strength and momentum.

As shown in FIGS. 6 and 7, the control interface device 174 can include an extension member 218 coupled to a fifth support member 215 at joint 235, which forms axis 225. The DOF about axis 225 represents a rotational DOF that can correspond to the DOF about axis 325 of the slave arm 300 and human wrist rotation. The fifth support member 215 is coupled to a sixth support member 216 at joint 236, which forms axis 226. The DOF about axis 226 represents a rotational DOF that can correspond to the DOF about axis 326 of the slave arm 300 and human wrist abduction/adduction. The sixth support member 216 is coupled to a seventh support member 217 at joint 237, which forms axis 227. The DOF about axis 227 represents a rotational DOF that can correspond to the DOF about axis 327 of the slave arm 300 and human wrist flex/extend. Thus, three separate joints of the control interface device 174 can correspond to the last three DOF of the slave arm 300 and to the human wrist.

The control interface device 174 can include structure that positions the wrist DOF of the user in sufficient alignment with the corresponding DOF of the control interface device 174 about axes 225, 226, and 227. The control interface device is configured to support a handle 202 such that when the user is grasping the handle to manipulate the control interface device 174, the user's wrist is appropriately positioned relative to the DOF of the control interface device 174 corresponding to the DOF of the user's wrist.

The extension member 218 can include a mounting bracket 148 configured to couple the control interface device 174 to the slave arm, such as to support member 314. In one aspect, the extension member 218 can be configured to position the joint 235 in front of the user's hand. The extension member 218 can also provide an offset for the axis 225 relative to the slave arm. The extension member 218 can be configured to position the axis 225 to sufficiently align with the corresponding DOF of the user's wrist. The fifth support member 215 can offset the joint 236 to be on a side of the user's wrist and can be configured to position the joint 236 behind the handle 202, such that the user's wrist will be sufficiently aligned with the axis 226. The sixth support member 216 can offset the joint 237 to be on another side of the wrist. The handle 202 is offset forward of the joint 237, such that when the user grasps the handle, the user's wrist will be sufficiently aligned with the axis 227. The seventh support member 217 can be configured to position the handle 202 beyond, or in front of, the axes 226, 227. In one aspect, the axes 225, 226, 227 can be orthogonal to one another and can be configured to sufficiently align with the DOF of the user's wrist.

In certain aspects, the extension member 218 can provide an offset for the axis 225 relative to the slave arm to provide a space for the user's arm and can position the slave arm to a side of the user's arm. For example, the extension member 218 can position the axis 225 such that it is sufficiently aligned with the corresponding wrist DOF of the user when the user is grasping the handle 202 and provide enough room for the user's arm next to the slave arm.

In other aspects, the fourth support member 214, the extension member 218, the fifth support member 215, the sixth support member 216, and the seventh support member 217 can be configured to provide sufficient space around the handle to accommodate buttons, switches, levers, or other control structures to allow the user to control the slave arm and/or an end effector.

Position sensors can be associated with joints 235, 236, 237 to sense a change in position of the support members 215, 216, 217 and/or the extension member 218. Actuators can provide load acting about the DOF associated with axes 225, 226, 227 formed by joints 235, 236, 237, respectively. Load sensors can measure load acting about the DOF associated with these axes. The actuators can be fluidly coupled to servo valves, which are electrically coupled to GDC and can receive position and/or load data from sensors, such as the position sensors and load sensors, to operate the actuators. In one aspect, there is one load sensor for each DOF of the control interface device 174. In another aspect, several DOF of the control interface device 174 can be accounted for with a multi DOF load sensor. Additionally, single or multi DOF load sensors can be associated in any combination with axes 225, 226, 227, which correspond to the wrist DOF of the user.

In one aspect, a handle 202 can provide an interface with the user and to allow the user to operate the slave arm. The handle can be coupled to a support member, such as the seventh support member 217. In another aspect, the handle 202 can be coupled to a load sensor 268. Load sensor 268 can be configured to measure load in at least one DOF, and in one aspect, is a multi DOF load sensor. Thus, the load sensor 268 can be configured to measure load applied by the user to the handle 202. In one aspect, load data acquired at the handle 202 can be used to assist the user in manipulating and operating the slave arm, such as by torque assistance. Load sensor 268 at the handle 202 can provide load data for a DOF of the control interface device 174 that is in addition to load data acquired by another load sensor at the DOF of the slave arm. In another aspect, load data acquired at the handle 202 can be used to assist the user in manipulating and operating the control interface device 174, such as by torque assistance. Load sensor 268 at the handle 202 can provide load data for a DOF of the control interface device 174 that is in addition to load data acquired by another load sensor at the DOF of the control interface device 174. Thus, the load data from load sensor 268 can be used to enhance the ability of the user to manipulate and maneuver the slave arm and/or the control interface device 174, as discussed herein.

In the present disclosure, it should be recognized that references to specific sensors in the figures, such as load sensors and position sensors, are referring primarily to locations of the sensors in the figures, not necessarily to the sensors themselves. For example, load sensor 268 may be disposed within a housing at the location identified in FIG. 6. Similarly, position sensors may be disposed within housings or otherwise associated with various DOF at the locations identified in the figures.

With a multi DOF load sensor 268 coupled to the slave arm, the user can apply a force to the load sensor that is translated to a load value in multiple DOF. The load value can be communicated from the control interface device 174 to a slave torque assist control, which can scale the torque values sufficient to assist the user to move the slave arm. In one aspect, the torque values applied may be insufficient to move the slave arm without assistance from the user. In another aspect, the torque values applied may be sufficient to move the slave arm without assistance from the user. The torque values for each joint associated with one of the DOF of the load sensor can be summed with the torque outputs of the slave gravity compensation and the torque from the slave arm torque. The torque values can assist the user in moving the slave arm in a direction indicated by the user through the multi DOF load cells. While one DOF load cell has been described, a greater number of load cells may be used, depending on the interface at the slave arm.

Utilizing load sensor 268 to assist the user in moving the slave arm and/or the control interface device 174 allows the user to fluidly and easily move the slave arm and/or the control interface device 174. For example, torque assistance can be provided based on data gathered from the load sensor 268, which can be used to assist the user in moving the control interface device 174 when force feedback is received at the control interface device 174. The torque assistance can also help the user to overcome mass and inertial forces when accelerating and decelerating the slave arm. Such forces may fatigue the user over time or provide difficulty in controlling the slave arm. With the torque assistance that is made possible through the use of load sensor 268, the user can provide small amounts of force in a desired direction to move the slave arm in spite of slave arm mass, payload mass, inertial forces, feedback forces, frictional forces, and other forces that can cause movement of the slave arm to be resistive. The amount of torque assistance can be varied to provide an acceptable amount of torque assistance to the user.

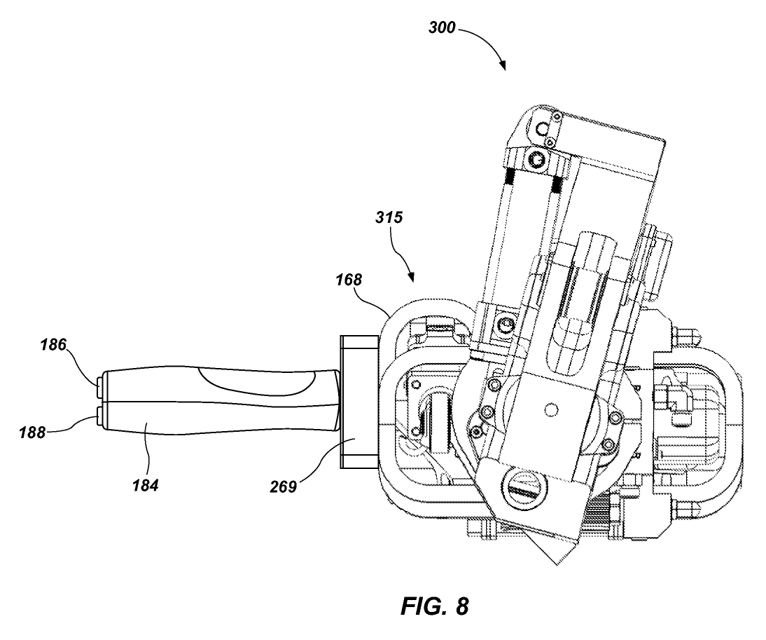

With reference to FIG. 8, in another aspect, illustrated is a control interface device 184 in the form of a handle coupled to the fifth support member 315 of the slave arm 300 via a load sensor 269 and mounting plate 168. Two slave arm DOF corresponding to axes 326, 327 are extended beyond the support member 315 to which the control interface device 184 is coupled. Thus, in one aspect, the control interface device 184 can receive force reflection from these two DOF of the slave arm. In other words, one DOF separates the force reflected portion of the slave arm and the coupling location for the control interface device 184. In another aspect, the control interface device 184 can receive force reflection from these two DOF of the slave arm in addition to the slave arm DOF corresponding to axis 325, about which support member 315 can rotate. In this case, no DOF separates the force reflected portion of the slave arm and the coupling location for the control interface device 184.

The load sensor 269 can measure load in at least one DOF. In one aspect, the load sensor 269 is a multi DOF load sensor capable of measuring load in at least five DOF. Additionally, by utilizing load data from the load sensor 269 in the at least five DOF, torque assistance can be employed to allow the user to manipulate the slave arm at every DOF between the fifth support member 315 to the base 310 by grasping and moving the handle 184. The DOF of the slave arm corresponding to axes 326, 327 can also be controlled by the user with the control interface device 184. For example, buttons 186, 188 can be configured to cause rotation of the slave arm support members 316, 317 about axes 326, 327, respectively. Thus, with the control interface device 184, the user can control the slave arm in every DOF of the slave arm.

In one aspect, the end effector 390 can be controlled or operated with the control interface device 184 via a trigger, dial, lever, button, or the like, which can function to adjust and manage an end effector as desired. For example, one or more adjustment buttons, such as buttons 186, 188, may be used to control the strength of a magnetic force of a magnetic end effector, the flame of an end effector welding torch, the rpm of an end effector saw, or other such controls of an end effector coupled to the slave arm. The control interface device can enable a user to switch the power on or off and/or adjust the settings dependent upon the type of end effector tool that is coupled to the teleoperated robotic system. An end effector can incorporate a variety of tools and other useful devices such as, but not limited to, an adjustable clamp, a claw having one or more finger-like extensions, variable and non-variable electromagnets, and so forth. An end effector can additionally include inspection devices or tools such as bar code scanners, infrared scanners, coordinate measuring tools, as well as other types of tools such as welding torches and implements, saws, hammers, and so forth. It is further contemplated that an end effector can include detectors and analyzers for harmful matter such as radiation, chemicals, and so forth, thereby enabling detection and analysis of harmful substances. In a particular aspect, the end effector can be configured to grasp human hand tools. In this case, the control interface device 184 can enable the user to not only control the end effector for grasping the hand tool, but also provide the user with the ability to operate the hand tool. Such control at the control interface device 184 may be accomplished with buttons, dials, levers, triggers, or the like that can cause the end effector to operate the hand tool.

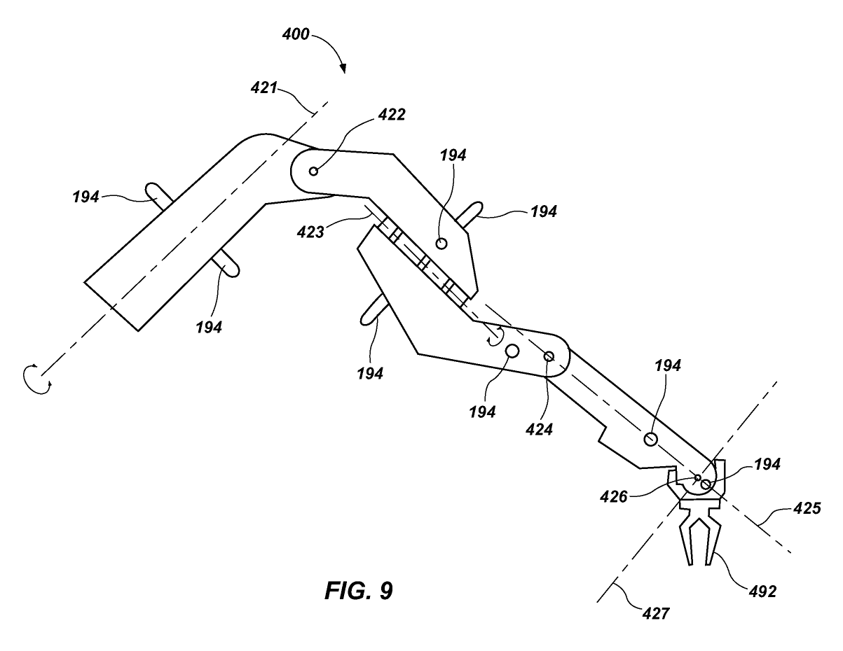

With reference to FIG. 9, a variety of possible coupling locations for a control interface device 194 to a slave arm 400 are illustrated. The control interface device 194 can be located on any of the support members of the slave arm and at any suitable location and in any suitable orientation with respect to the support members. For example, the control interface device 194 can be disposed on a bottom side, a top side, an inside, or an outside of the slave arm support members. In one aspect, the control interface device 194 can be coupled to the support member such that the control interface device 194 is substantially perpendicular to an axis of rotation for the support member. For example, the control interface device 194 can be mounted on at least one of the various support members of the slave arm so as to be perpendicular to at least one of axes 421-427. In a particular aspect, a control interface device 194 can be coupled to a plurality of slave arm support members to provide the user with convenient grasping locations on the slave arm to manipulate the slave arm in multiple DOF. The control interface device 194 can be any type of control interface device discussed above. Thus, in one aspect, the control interface device 194 can be coupled to the slave arm via a load sensor, which can enable torque assist for the user when controlling the slave arm. In another aspect, the control interface device 194 can include buttons or other control features to control and operate an end effector 492.

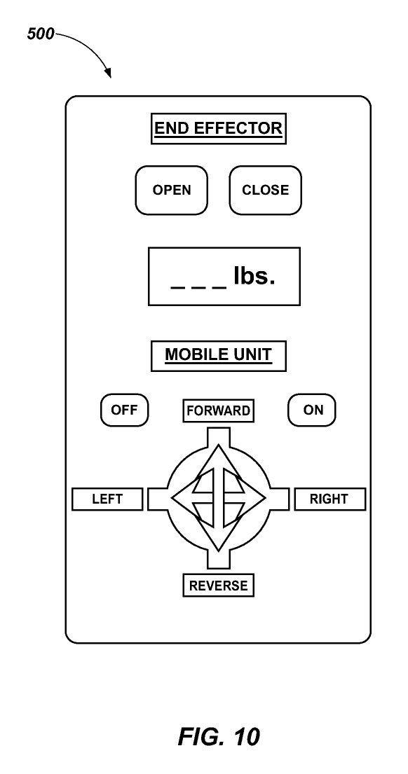

With reference to FIG. 10, illustrated is a remote control 500 for a mobile robotic lift assistance system. The remote control 500 can be wired or wirelessly coupled to the mobile robotic lift assistance system. The remote control can be removably attachable to the mobile robotic lift assistance system, such that the user can operate the mobile robotic lift assistance system when located away from the standard controls of the mobile robotic lift assistance system.

In one aspect, the user can operate the mobile robotic lift assistance system with the remote control 500 while in the zone of operation. For example, the user may be engaged in the process of manually positioning the slave arm to properly position a payload and may need to adjust the position of the mobile platform unit to complete the task without the inconvenience of leaving the slave arm. With the remote control 500, the user can operate and drive the mobile platform to a more suitable location without leaving the slave arm. The remote control 500 can provide power on/off of the mobile platform, as well as forward and reverse drive, and left and right steering.

In another example, the user can operate the end effector while in the zone of operation. As with the example above, it may be inconvenient for the user to leave the slave arm to operate the end effector from the platform. Thus, with the remote control 500, the user can operate the end effector while at the slave arm, where the operation of the end effector can be closely monitored by the user. The remote control 500 can include end effector controls for various end effector types, such as open/close of a clamp and a scale function with a display.

In another aspect, the robotic lift system may be configured to allow the user to be able to control the operation of the mobile platform unit directly from the robotic arm. For example, and not intended to be limiting in any way, in one aspect, the user may be able to control the mobile platform when the robotic arm is caused to be put into a certain pre-determined configuration or position, such as in a fully extended position, or at least a position extended enough to initiate and facilitate mobile platform control. This positioning of the robotic arm can initiate a “follow-me” mode in the system, wherein the mobile platform operates to move in a direction of an applied force to the slave arm. Thus, by manipulating the robotic arm in various directions while in the “follow-me” mode, the mobile platform will be caused to respond accordingly, thus allowing the user to move the mobile platform in a forward direction, a backward direction, and to steer the mobile platform.

This mode of operation can provide the user with the ability to essentially “drive” and operate the mobile platform from or while at the robotic arm, and without requiring use of an external remote control, such as the remote control 500 described above. For example, the user can be in the zone of operation with the robotic arm. To drive the mobile platform forward, the user can apply a force to the robotic arm to extend the robotic arm in a direction in front of the mobile platform. Once extended to a predetermined degree, the robotic system will automatically initiate the “follow-me” mode and the mobile platform will drive forward in the direction of the applied force until force is removed, such as when the robotic arm has been retracted a predetermined degree or amount. Removing the applied force can cause the mobile platform and the robotic system to exit the “follow-me” mode. In another aspect, rather than being automatically initiated, a user may selectively initiate the “follow-me” mode by manually selecting the “follow-me” mode using the control system. In some embodiments, the user may execute an override function to place the system in and out of this mode as desired. This may particularly be useful when the full reach of the robotic arm is needed in a work function.

The extremity control system and operator control within the zone of operation provides several advantages or benefits as compared with other lift and/or transport systems where operator control is more conventional and without the zone of operation. For example, and not intended to be limiting in any way, extremity control of a robotic arm provides faster and more intuitive manipulation as the user's movements are directly imputed to the robotic arm. In addition, extremity control provides improved eye/hand coordination over teleoperated robotic systems as the user is able to directly manipulate the robotic arm with his/her own hand rather than through a master control arm. In addition, the operator is not in a kinematically equivalent relationship, at least not fully, with the robotic arm, as there is no need for this. These advantages lead to a very efficient and intuitive system that can help bridge logistical lift gaps in various settings. Other advantages not specifically discussed herein will be apparent to those skilled in the art. As such, those mentioned are not to be construed as limiting in any way.

While the foregoing examples are illustrative of the principles and concepts discussed herein, it will be apparent to those of ordinary skill in the art that numerous modifications in form, usage and details of implementation can be made without the exercise of inventive faculty, and without departing from those principles and concepts. Accordingly, it is not intended that the principles and concepts be limited, except as by the claims set forth below.

What is claimed is:

1. A mobile robotic lift assistance system comprising:
a multi-degree of freedom robotic arm that operates to provide a lift function in relation to a payload as directed by an operator, said robotic arm comprising a mounting end and a working end positionable in three-dimensional space within a zone of operation;
an end effector operatively coupled to said working end of said robotic arm, that acts on said payload to perform an intended work function as directed by the operator;
a gravity compensation mode, wherein the robotic arm and the end effector are gravity compensated in said three-dimensional space; and
an extremity control system located about said robotic arm that facilitates extremity control of said mobile robotic lift assistance system to lift and manipulate said payload, wherein said robotic arm and said end effector are each controlled locally by said operator at said robotic arm.

2. The mobile robotic lift assistance system of claim 1, further comprising a torque assistance function, wherein at least one load sensor associated with the slave arm provides load data to at least one of the degrees of freedom, wherein actuated movement of the slave arm in response to a load applied to the slave arm by the user is facilitated, thereby reducing the forces necessary to move the slave arm.

3. A mobile robotic lift assistance system, comprising:
a mobile platform unit maneuverable about a ground surface and within an operating environment;
a multi-degree of freedom robotic arm that operates to provide a lift function in relation to a payload as directed by an operator, said robotic arm comprising a mounting end operatively supported about said mobile platform unit, and a working end positionable in three-dimensional space within a zone of operation;
an end effector operatively coupled to said working end of said robotic arm, that acts on said payload to perform an intended work function as directed by the operator; and
an extremity control system located about said robotic arm that facilitates extremity control of said mobile robotic lift assistance system to lift and manipulate said payload, wherein said robotic arm and said end effector are each controlled locally by said operator at said robotic arm.

4. The mobile robotic lift assistance system of claim 3, further comprising a gravity compensation mode, wherein the robotic arm and any supported payload is gravity compensated in said three-dimensional space.

5. The mobile robotic lift assistance system of claim 3, wherein said extremity control system comprises a control interface device supported about the robotic arm that interfaces with the operator to facilitate extremity control.

6. The mobile robotic lift assistance system of claim 5, wherein the control interface device comprises a handle supported about a support member graspable by said operator to manipulate said robotic arm.

7. The mobile robotic lift assistance system of claim 5, wherein the control interface device comprises a multiple degree of freedom gripper that facilitates teleoperation of the robotic arm from the robotic arm, and active, actuated control of at least one DOF in the robotic arm beyond a mounting location of the gripper.

8. The mobile robotic lift assistance system of claim 7, wherein the multiple degree of freedom gripper comprises one or more actuators and load sensors to facilitate force reflection as applied to the gripper from the robotic arm.

9. The mobile robotic lift assistance system of claim 5, wherein said control interface device is located at a distal region of said robotic arm.

10. The mobile robotic lift assistance system of claim 5, wherein said control interface device comprises an end effector control system that facilitates control and manipulation of said end effector by said operator.

11. The mobile robotic lift assistance system of claim 10, wherein said end effector control system is integrally formed with said control interface device.

12. The mobile robotic lift assistance system of claim 3, wherein said robotic arm is directly coupled to and extends from said mobile platform unit.

13. The mobile robotic lift assistance system of claim 3, further comprising a vertical boom supported about and extending from said mobile platform unit, wherein said robotic arm is supported about said vertical boom to extend the reach of said robotic arm.

14. The mobile robotic lift assistance system of claim 13, wherein said vertical boom comprises a multi-degree of freedom configuration.

15. The mobile robotic lift assistance system of claim 3, further comprising a mode that facilitates operation of the mobile platform unit by positioning the robotic arm in a pre-determined position, wherein the mobile platform unit advances in the direction of the applied force.

16. A method for controlling a mobile robotic lift assistance system, said method comprising:
obtaining a robotic arm as part of a mobile robotic lift assistance system;
interfacing directly with the robotic arm through an extremity control system comprising a control interface device supported about the robotic arm; and
manipulating the control interface device to command and control one or more functions of the mobile robotic lift assistance system, and at least a movement of the robotic arm and an end effector operation.

17. The method of claim 16, further comprising controlling a mobile platform unit supporting the robotic arm, through the extremity control system.

18. The method of claim 17, wherein controlling a mobile platform unit comprises initiating a “follow-me” mode that facilitates operation of the mobile platform unit by positioning the robotic arm in a pre-determined position, and applying a force, wherein the mobile platform unit advances in the direction of the applied force.

19. The method of claim 16, further comprising interfacing with a plurality of control interface devices located about the robotic arm to manipulate various degrees of freedom within the robotic arm.
